(19) United States
(12) Patent Application Publication
(10) Pub. No.: US 2006/0193246 A1
(43) Pub. Date: Aug. 31, 2006

(54) High service availability ethernet/ip network architecture

(75) Inventors: Valerie Brute De Remur, Fontenay (FR); Patrick Dillon, Versailles (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: Thales, Neuilly Sur Seine (FR)

(21) Appl. No.: 10/545,572

(22) PCT Filed: Feb. 16, 2004
(86) PCT No.: PCT/EP04/50137

§ 371 Date: Aug. 16, 2005

(30) Foreign Application Priority Data
Feb. 18, 2003 (FR) 03/01951

(51) Int. Cl. H04J 1/16; H04L 12/26; H04L 12/56; H04L 12/28; H04J 3/14

(52) U.S. Cl. 370/216; 370/241; 370/389

(57) ABSTRACT

The architecture according to the invention is a high service availability Ethernet/IP network architecture, that allows data flows to be conveyed without interruption to service, these flows coexisting with other flows that tolerate interruption to service, and the architecture is characterized in that the network consists of two fault tolerant network architectures that are superposed, one of which is implemented in the form of a single network having a mesh infrastructure and the other in the form of an infrastructure consisting of two independent networks.

The present invention relates to a high service availability Ethernet/IP network architecture.

Many control systems require very high availability and this involves a service interruption time that is minimal and brought under control in the event that an element in these systems fails. This availability requirement is expressed during operation of the systems and hence must, during systems engineering analysis, be applied to the various elements forming the system. This requirement especially applies to the means of communication (data, voice, video) between the various elements forming a system.

In the case of an air traffic control system, the maximum service interruption time for communication between system elements is in the region of 2 seconds for data and 0.5 seconds at most for voice and certain “real time data” (radar flows).

The design of the communication network architecture associated with local or distributed redundancy mechanisms for equipment forming the network enables this availability requirement to be met reasonably well, depending on the technologies.

Since cost is an overriding factor when designing systems, the use of commercial standards and commercial off-the-shelf (COTS) equipment is unquestionable. For communication networks, the Ethernet standard is imposed at the physical layer and the IP protocol (IP: Internet Protocol) at the network layer.

By its success, the Ethernet standard effectively killed off the FDDI standard which intrinsically met the requirements of these systems with a maximum communication service interruption time in the region of a few hundreds of milliseconds.

In the current state of the art, a maximum communication service interruption time of about 2 seconds can be achieved using Ethernet technology and associated equipment. This level of performance meets the requirement for data but not for voice and other real time flows now transported over IP (for example, VOIP: Voice over IP).

The subject of the present invention is an Ethernet/IP architecture meeting the following requirements:
Use of COTS equipment based on the Ethernet standard
Use of standard protocols
No restriction on network size and configuration
Transparent to applications
Minimal and only software-based development
Allows coexistence of heterogeneous terminal equipment.

The architecture according to the invention is a high service availability Ethernet/IP network architecture that allows data flows to be conveyed without interruption to service, these flows coexisting with other flows that tolerate interruption to service, and the architecture is characterized in that the network consists of two fault tolerant network architectures that are superposed, one of which is implemented in the form of a single network having a mesh infrastructure and the other in the form of an infrastructure consisting of two independent networks.

According to another characteristic of the invention, the items of terminal equipment, since they have an availability requirement on the data flows they handle, are connected by two physical links to two separate items of equipment of the network infrastructures.

According to another characteristic, any type of terminal equipment communicates with any other type of terminal equipment.

According to yet another characteristic, the architecture is extensible in terms of redundancy.

According to yet another characteristic, the architecture is extensible in terms of network size.

According to yet another characteristic, the network is made up of routers.

The present invention will be better understood on reading the detailed description of an embodiment, given by way of nonlimiting example and illustrated by the accompanying drawings in which:

FIG. 1 is a block diagram of a known mesh network architecture,

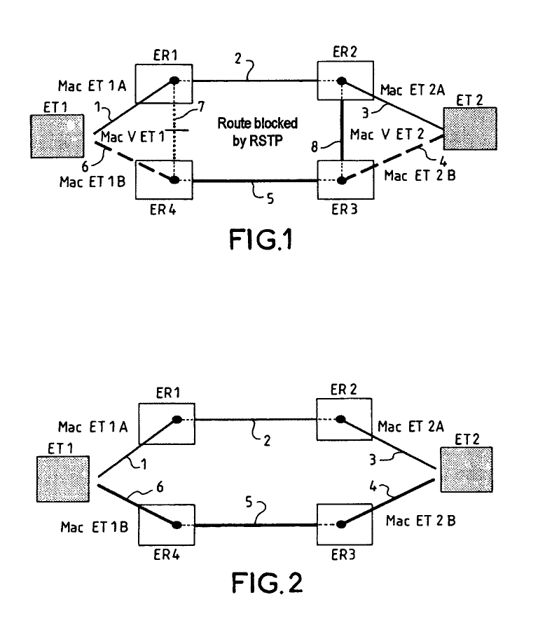

FIG. 2 is a block diagram of a known network architecture with two independent networks,

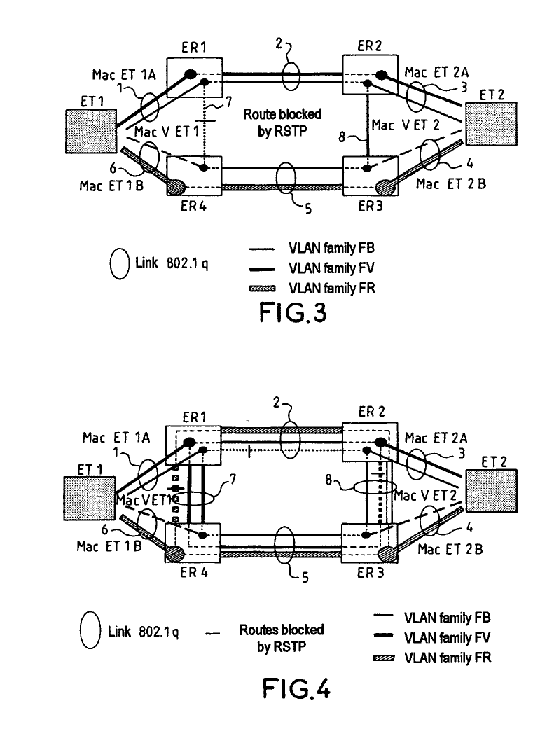

FIG. 3 is a simplified block diagram of an architecture according to the invention, and

FIGS. 4 to 7 are block diagrams of variants, according to the invention, of the architecture of FIG. 3.

The equipment that will be involved in the description that follows is either network infrastructure equipment (ER) or terminal equipment (ET). Network equipment mainly consists of Ethernet switches (for example, the Catalyst™ family of switches of the Cisco brand). Terminal equipment may be all types of information processing equipment (data or voice, for example) connected to the network. Among the items of terminal equipment, a distinction is drawn between:
ETS: terminal equipment that is single homed on the network (for example, a printer),
ETD: terminal equipment that is dual homed on the network (for example, a workstation),
ETDT: terminal equipment that is dual homed on the network and that handles sensitive real time flows (for example, a gateway radio).
   The block diagram of FIG. 1 represents an architecture based on a known elementary mesh network. This redundant architecture includes at least two items of terminal equipment of any type, labeled ET1 and ET2 respectively. Each ET is physically connected to two ERs. ET1 is connected by a link 1 to a first ER labeled ER1 which is connected to a second ER labeled ER2 by a link 2. ET2 is connected to ER2 by a link 3, and it is also connected by a link 4 to a third ER, labeled ER3. ER3 is connected by a link 5 to a fourth ER labeled ER4. The latter is connected by a link 6 to ET1. Links 7 and 8 connect ER1 to ER4 and ER2 to ER3 respectively. The links between the various elements forming the architecture are full duplex links over copper or optical fiber physical connections. This redundant architecture is based on the ETs being dual homed and the mesh network topology using the new RSTP standard (RSTP: Rapid Spanning Tree Protocol; IEEE 802.1w). With this architecture, the requirement of a maximum interruption of 2 seconds for communication between the two ETs is met. In the example represented, which relates to a normal service situation, links 4 and 6 are not used by ET1 and ET2, and link 7 is blocked by the RSTP protocol. Thus, only one of the physical connections between the ETs and the corresponding ERs is active at an instant T and has as address the “Mac V” virtual address of the equipment (address “Mac V ET1” for ET1 and “Mac V ET2” for ET2). A unique IP address is associated with the Mac V address. The other MAC addresses do not have IP addresses assigned to them.

If, for example, ET1 detects a connection failure of link 1, it switches from link 1 to link 6, activating the Mac V ET1 virtual address on the interface of link 6. To guarantee the system switchover time, a transmitted frame containing the Mac V ET1 address must be sent over the new active link (i.e. link 6 in the example) so that the ERs can update their port/MAC address correspondence tables. The detection time added to the switchover time, until the ERs have registered the change, is generally less than 2 seconds.

The dual homing function as described above exists by design in a number of COTS software systems (for example Linux (Bonding), Windows™, Tru64 (NetRAIN™), HP-UX™ (APA™)) and hardware systems (dual transceivers).

Due to the mesh topology employed, the loss of an ER or a network equipment interconnecting link triggers an RSTP calculation which reactivates the blocked link (link 7 in the example of FIG. 1) within 2 seconds.

This architecture therefore avoids any single point of failure and, in the event that an ER or a physical link fails, enables reconfiguration to take place in less than 2 seconds. Furthermore, it is based on standard solutions enabling a high deployment of COTS systems and does not require, in the case where this is not necessary, all the elements of the system to be dual homed so that they can communicate with each other. However, this architecture does not enable the requirement of less than 0.5 seconds for sensitive real time flows to be met.

That requirement can be met by adopting an architecture based on independent networks. Such an architecture is shown in FIG. 2. In this figure, as in the figures that follow, elements that are similar to those in FIG. 1 are assigned the same numerical references. Unlike the architecture of FIG. 1, that of FIG. 2 does not have links 7 and 8. ET1 and ET2 exchange information with each other through two independent networks. The first network passes through ER1 and ER2 and is made up of links 1 to 3 respectively, and the second network passes through ER3 and ER4 and is made up of links 4 to 6 respectively. The two physical connections of the two ETs (1 and 6, and 3 and 4) are active at the same time, as will be described below.

When an ET wants to transmit, it transmits the same information on both links at the same time. The receiving ET can either receive on only one link and switch the second link to a state for not receiving information, or, if it has enough processing power, receive on both links at the same time and discard duplicate information. In the first case, the requirement of less than 0.5 seconds can be met only if the frequency of reception of information is sufficiently high. In the second case, the non-interruption to service in the event of failure of an element forming the network (for example, an ER or a link), including the means connecting terminal equipment to the network, can be achieved.

This solution is well suited to real time flows using protocols such as RTP (“A Transport Protocol for Real-Time Applications”; IETF RFC 1889), where the elimination of duplicate information can be managed by sequence numbers. However, for other types of flows where the redundancy is less well handled by intrinsic means, the receive mechanisms are much more complex to implement and are not necessarily transparent to the applications and the network software stubs. One solution would be to transmit and receive only on one network at a time, but in that case the synchronization of all terminal equipment on the same network becomes problematic, especially in a distributed architecture.

Another drawback of this solution lies in the fact that all the items of equipment of the system must be capable of dual homing and provide this transmit and receive function on both networks, a feature which is proprietary.

The solution according to the present invention proposes superposing the architecture of the mesh network onto that of the independent networks and therefore benefiting simultaneously from the advantages of both these architectures. Such superposition is possible using VLAN technology (VLAN: Virtual Local Area Networks, see “VLAN trunking”, IEEE 802.1Q). Of course, other technologies that allow network architecture types to be superposed may be used in the architecture of the invention.

To this end, three VLAN families are applied to the items of equipment, as represented in FIG. 3. These families are labeled FV, FR and FB respectively. Family FV makes use of links 1 to 3 for the route, while family FR makes use of links 4 to 6 for the route. Family FB makes use of all links 1 to 8 for the route.

Family FB is dedicated to flows that can tolerate interruptions to service and routes through all the Ers, layer 2 loops being managed by a dedicated instance of RSTP/MSTP (for MSTP, see “Multiple STP”, IEEE 802.ls). Of course, protocols other than RSTP, providing for a fast configuration and managing layer 2 loops, can be implemented in the architecture of the invention.

As in the example of FIG. 1, the route of family FB over link 7 is blocked by the RSTP protocol under normal conditions.

The other two families (FV and FR) are dedicated to sensitive real time flows and route through different network equipment: ER1 and ER2 for family FV, ER3 and ER4 for family FR. The routes of each VLAN family are guaranteed to be different by an appropriate configuration of the ERs.

In this architecture, the redundancy associated with dual homing is managed by two independent mechanisms:
for flows circulating on VLAN family FB, the mechanism for changing MAC addresses, identical to that of the mesh network, is used,
for real time flows circulating on VLAN families FV and FR, the mechanism is identical to that of independent networks.

Thus, for the ETs (ETDs) not dealing with sensitive real time flows, only the redundancy mechanism of family FB is implemented, thereby allowing use of COTS software and hardware. For the other types of ET (ETDTs), both mechanisms must be implemented simultaneously, requiring software adaptation between layers 2 and 3 (link and IP).

However, this architecture can be implemented only if the following conditions are satisfied:
the ETs must connect to the ERs through a VLAN link supporting the 802.1Q standard (multiplexing of VLANs on a physical link),
since the MAC address of a dual homed link is not fixed, the sensitive real time flows can be transported only in a broadcast mode (for example, in multicast mode), i.e. from one point to at least one other point, which suits systems based on distributed architectures.

The architecture described with reference to FIG. 3 is relatively uncomplicated and easy to set up. Its performance can be further improved by using the new functions available in the ERs more widely.

The first of these new functions is the “IGMP snooping” function (IGMP: Internet Group Management Protocol; IETF RFC 1112 and 2236), which is a function implemented locally on an ER, and therefore a proprietary function. It acts only on flows transmitted in multicast mode.

Activating the IGMP snooping function on network equipment enables terminal equipment to receive only those multicast flows that they need for their tasks. Hence, their Ethernet links would not become congested with useless flows which, in addition, would require additional processing by them on reception.

The architecture represented in FIG. 4 provides for increased redundancy at the network layer, which is made possible by giving the ERs access to all the VLANs. A different route is provided for VLAN families FV and FR (when all the ERs are operational) through the use of the “load balancing” function of the RSTP/MSTP standards. Instead of only one instance dedicated to the VLANs of family FB, three RSTP instances of MSTP are used. Thus a partially meshed topology is obtained, as represented in FIG. 4. From the physical point of view, this figure is identical to FIG. 3. The only difference is that all the VLAN families (FV, FR and FB) route over all the inter-ER links. Furthermore, under normal conditions, RSTP blocks one route for each family. In the example represented, the route of family FB is blocked on link 2, that of family FV is blocked on link 8 and that of family FR is blocked on link 7, although it is of course understood that these blocked states could be assigned in other ways, for example on the same link.

This architecture enables the system to better withstand double failures because of the possible reconfigurations related to RSTP/MSTP; VLAN families FR and FV benefit from the redundancy of the mesh architecture.

The RSTP/MSTP reconfiguration possibilities can be further increased by using one totally meshed topology as represented in FIG. 5. The architecture of FIG. 5 is similar to that of FIG. 4, but additionally includes a physical link 9 between ER1 and ER3 and another physical link 10 between ER2 and ER4. These two links 9 and 10 form routes for the three families FV, FR and FB. Under normal conditions, the RSTP protocol blocks, for example, the routes of the three families FV, FR and FB on links 7, 9 and 10.

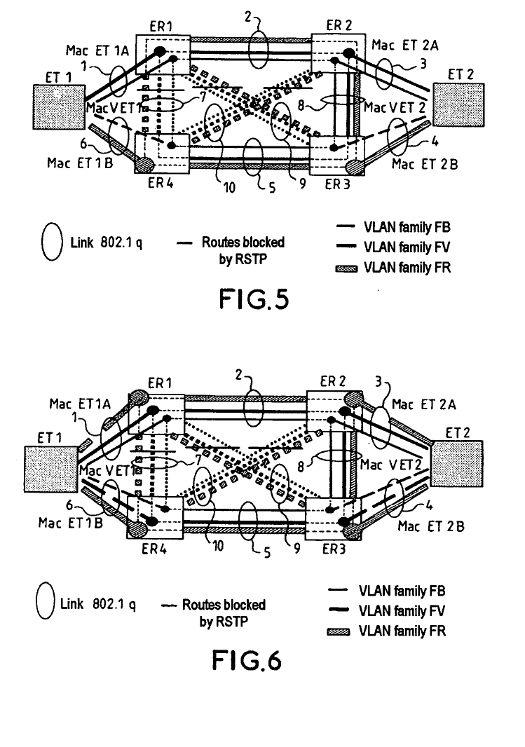

The solution can be further enhanced and the redundancies at the ETs increased by making use of dual homing for VLAN families FR and FV as represented in FIG. 6. From the physical point of view, the architecture of FIG. 6 is identical to that of FIG. 5. The difference lies in the fact that links 1, 3, 4 and 6 of the two ETs form routes for the three families FV, FR and FB. The mechanism for switching between families FR and FV turns out to be complex and must be implemented sensibly, especially if IGMP snooping is used.

All the mechanisms described above are not restrictive and accommodate any redundant network topology and the network can even be extended by layer 3 routing by a mapping of VLANs.

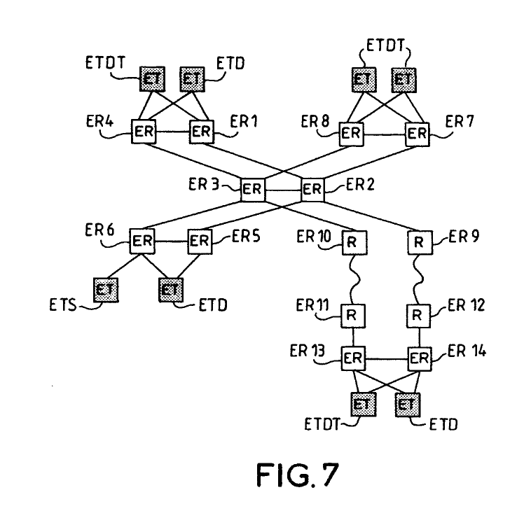

FIG. 7 represents a nonlimiting example of an extended architecture. In this example, the basic architecture, as described with reference to FIGS. 3 to 6, is repeated several times over. This extended architecture includes, in the present example, the four “basic” ERs, ER1 to ER4. ER2 and ER3 are connected to other ERs, i.e. ER5 to ER10. In this example, ER9 and ER10 are routers. The latter are in communication with two other ERs (ER1 and ER12), which are also routers, and which are each connected to a “conventional” ER (like ER1 to ER8), i.e. ER13 and ER14 respectively. ER1, ER4, ER5 to ER8, ER13 and ER14 are connected to terminal equipment. Note that the items of terminal equipment can be any one of the three types mentioned at the start of the detailed description (ETS, ETD or ETDT), it being understood that the ETSs can be connected physically only to one ER at a time, as is the case for the ETS connected to ER6.

In conclusion, it will be noted that the network architecture described, based on VLAN technology, dual homing and the RSTP/MSTP protocols, advantageously uses both a mesh network architecture and one based on independent networks. It enables the stringent redundancy and availability requirements of systems in these domains to be met with the following characteristics:
use of COTS software or hardware for equipment which does not need to handle sensitive real time flows;
use of COTS systems for the network infrastructure;
use of standard protocols: VLAN, RSTP and MSTP;
no limit on network size;
very little impact on applications since the implementation is transparent from layer 3 (IP);
software development limited to a slight adaptation between layers 2 and 3 (IP) for terminal equipment that needs to handle sensitive real time flows;
possibility for receivers with sensitive real time flows at their disposal to implement an algorithm for switching over or for managing information duplication according to the requirements of the system. In the latter case, this algorithm enables them to provide continuity of service in the event of a failure;
possibility of enabling the coexistence of heterogeneous equipment such as:
   equipment with a single connection such as a printer,
   equipment with a redundant connection, such as management stations, and not handling sensitive real time flows,
   equipment handling all types of flows.

1. An Ethernet/IP network architecture that allows data flows to be conveyed without interruption to service, these flows coexisting with other flows that tolerate interruption to service, the network consisting of two fault tolerant network architectures that are superposed, one of which is implemented in the form of a single network having a mesh infrastructure and the other in the form of an infrastructure consisting of two independent networks.

2. The architecture according to claim 1, wherein the items of terminal equipment, since they have an availability requirement on the flows they handle, are connected by two physical links to two separate items of equipment of the network infrastructures.

3. The architecture according to claim 2, wherein any type of terminal equipment communicates with any other type of terminal equipment.

4. The architecture as claimed according to claim 2, wherein it is extensible in terms of redundancy.

5. The architecture as claimed according to claim 1, wherein it is extensible in terms of network size.

6. The architecture according to claim 5, wherein the network is made up of routers.

7. The architecture as claimed according to claim 3, wherein it is extensible in terms of redundancy.

8. The architecture as claimed according to claim 2, wherein it is extensible in terms of network size.

9. The architecture as claimed according to claim 3, wherein it is extensible in terms of network size.
